(19) United States
(12) Patent Application Publication
(10) Pub. No.: US 2003/0206087 A1
(43) Pub. Date: Nov. 6, 2003

(54) Magnetic system having three-dimensional symmetry for three phase transformers

(75) Inventor: Vadim Raff, Matthews, NC (US)

Correspondence Address: SQUARE D COMPANY, 1415 South Roselle Road, Palatine, IL, 60067, US

(73) Assignee: Square D Company

(21) Appl. No.: 10/140,381

(22) Filed: May 6, 2002

(51) Int. Cl. H01F 30/12

(52) U.S. Cl. 336/182

(57) ABSTRACT

A core for a three-phase transformer, the core comprising a centrally-disposed flux collector and three generally C-shaped core leg sections peripherally arranged about the flux collector in an angularly spaced relationship and connected to the flux collector. The three core leg sections are each adapted to support a transformer coil and the flux collector is adapted to provide a low reluctance path to magnetically link the coils of the transformer.

### TECHNICAL FIELD

The invention relates to a transformer core and coil assembly, and more particularly, to a compact core and coil assembly for three-phase transformers that has three-dimensional symmetry.

### BACKGROUND OF THE INVENTION

Transformers are utilized extensively in a variety of electrical and electronic applications to perform various functions, such as, for example, stepping voltages up or down, coupling signal energy from one stage to another, or impedance matching. Three-phase transformers are utilized in three-phase power applications, such as utility power applications. In three-phase power applications, transformers typically perform the functions of stepping voltages down from utility power. In such applications, there is an increasing need to provide more compact transformers that occupy less space, especially in applications involving confined spaces, such as commercial buildings, production facilities, shopping malls, or open substations.

Most three-phase transformers have a planar core and coil construction wherein each of the core sheets, or layers, are all parallel to each other, as shown in FIGS. 1 and 2. Typical planar three-phase cores are either constructed in an Evans core design (3-leg) or a 5-leg design. A 3-leg core design has three leg portions and two core windows. A 5-leg design has five leg portions and four core windows. Because of their planar construction, planar core designs in three-phase transformers have a long length, especially in 5-leg designs. A drawback associated with planar designs is that the long length of the core results in a longer path for the magnetic flux of the left and right phases compared to the middle phase. Another drawback is the amount of core material required to construct a planar core.

A theoretical solution to the drawbacks of a planar core is a core design having three-dimensional symmetry. Instead of each leg of the core lying within a single plane, a core having three-dimensional symmetry has its legs arranged about a central axis. In this type of construction, each leg has magnetic flux path of equal length. Thus, a core and coil assembly having three-dimensional symmetry theoretically is more efficient than the planar-type assembly. Although theoretically more efficient, there are many problems associated with constructing a core and coil assembly having three-dimensional symmetry that will actually perform at these theoretical levels. Most notable are the actual flux losses associated with the joint of the three legs at the central axis of the core.

The present invention provides a solution to the problems associated with real-world implementation of a magnetic system having three-dimensional symmetry for a three-phase transformer.

### SUMMARY OF THE INVENTION

A core for a three-phase transformer, the core comprising a centrally-disposed flux collector and three generally C-shaped core leg sections peripherally arranged about the flux collector in an angularly spaced relationship and connected to the flux collector. The three core leg sections are each adapted to support a transformer coil and the flux collector is adapted to provide a low reluctance path to magnetically link the coils of the transformer.

According to another aspect of the present invention, the flux collector has either a circular-shaped or generally triangular-shaped periphery to which the core leg sections are connected.

According to another aspect of the present invention, the core includes two flux collectors.

According to yet another aspect of the present invention, the core leg sections and the flux collector are formed from core stock comprising laminated sheets of magnetic material.

These and other aspects of the present invention will be apparent after review of the detailed description of the preferred embodiments, the drawings and the claims.

### BRIEF DESCRIPTION OF THE DRAWINGS

FIG. 1 is a perspective view of a prior art planar core and coil construction of a three-phase transformer.

FIG. 2 is a top plan view of the planar core and coil construction of FIG. 1.

FIG. 3 is a perspective view of a first embodiment of a three-dimensional core in accordance with the present invention.

FIG. 4 is a top plan view of the three-dimensional core of FIG. 3.

FIG. 5 is a perspective view of a second embodiment of a three-dimensional core in accordance with the present invention.

### DETAILED DESCRIPTION OF THE PREFERRED EMBODIMENTS

While the present invention will be described fully hereinafter with reference to the accompanying drawings, in which particular embodiments are shown, it is to be understood at the outset that persons skilled in the art may modify the invention herein described while still achieving the desired result of this invention. Accordingly, the description which follows is to be understood as an informative disclosure of specific embodiments under the invention directed to the understanding of persons skilled in the appropriate arts and not as limitations of the present invention.

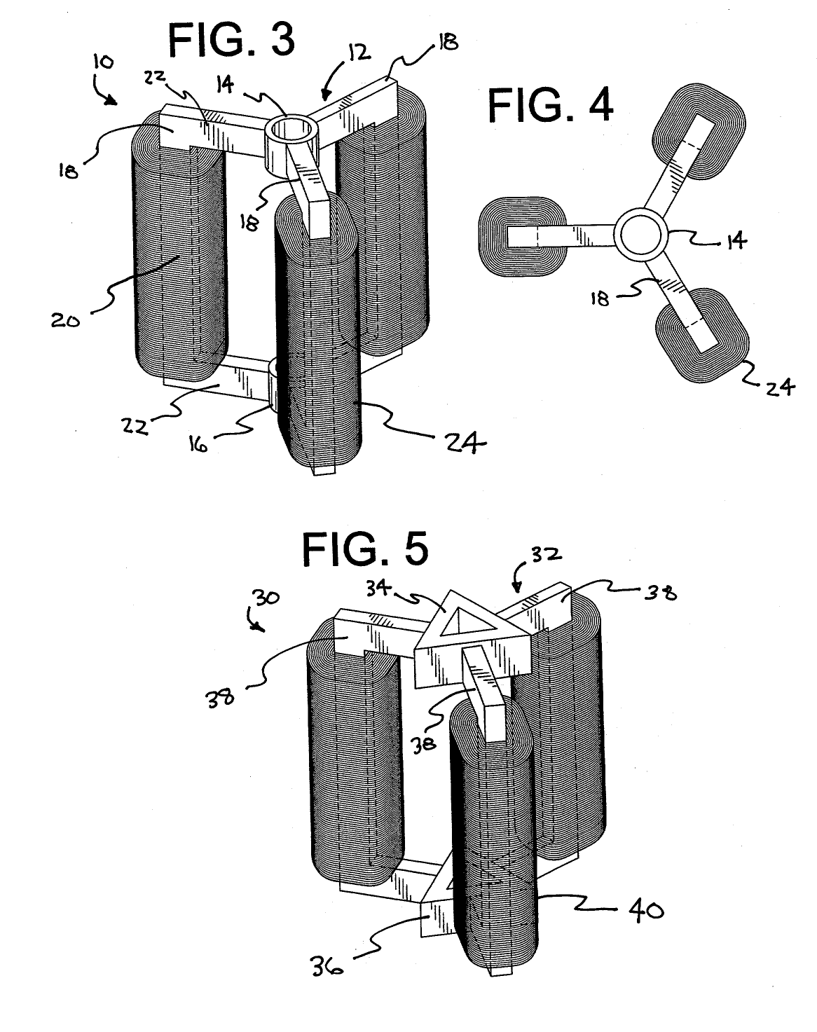

Referring to FIG. 3, a three-phase transformer 10 includes a core 12 in accordance with the present invention. The core 12 includes a pair of centrally-disposed flux collectors 14, 16 and three generally C-shaped core leg sections 18 peripherally arranged about the flux collectors 14, 16 in an angularly spaced relationship, as shown in FIG. 4. The core leg sections 18 are formed from core stock comprising laminated sheets of magnetic material. Preferably, the flux collectors 14, 16 are also formed from similar core stock. Each of the core leg sections 18 comprise a leg member 20 and two yoke members 22 each transversely disposed to the leg member 20 to form a general C-shape. The yoke members 22 of the core leg sections 18 are connected to the flux collectors 14, 16, as shown in FIG. 3. The connection between the flux collectors 14, 16 and the core leg sections is preferably by a welded joint. In the embodiment shown in FIGS. 3 and 4, the flux collectors 14, 16 have a circular-shaped periphery to which the core leg sections 18 are connected. The three core leg sections 18 are each adapted to support a transformer coil 24 and the flux collectors 14, 16 are adapted to provide a low reluctance path to magnetically link the coils 24 of the transformer 10.

In an embodiment shown in FIG. 5, a three-phase transformer 30 includes a core 32 having a pair of flux collectors 34, 36 each having a generally triangular-shaped periphery to which three generally C-shaped core leg sections 38 are connected. The three core leg sections 38 are each adapted to support a transformer coil 40 and the flux collectors 34, 36 are adapted to provide a low reluctance path to magnetically link the coils 40 of the transformer 30.

In a preferred embodiment, the core leg sections 18, 38 are constructed from thin sheets of magnetic steel stacked together and insulated therebetween to limit induced Eddy currents, which limits generated heat and losses within the magnetic system of the transformer to acceptable levels. In a preferred embodiment, the flux collectors 14, 16, 34, 36 are constructed from the same material as that of the core leg sections 18, 38 to provide a low reluctance path to the magnetic flux.

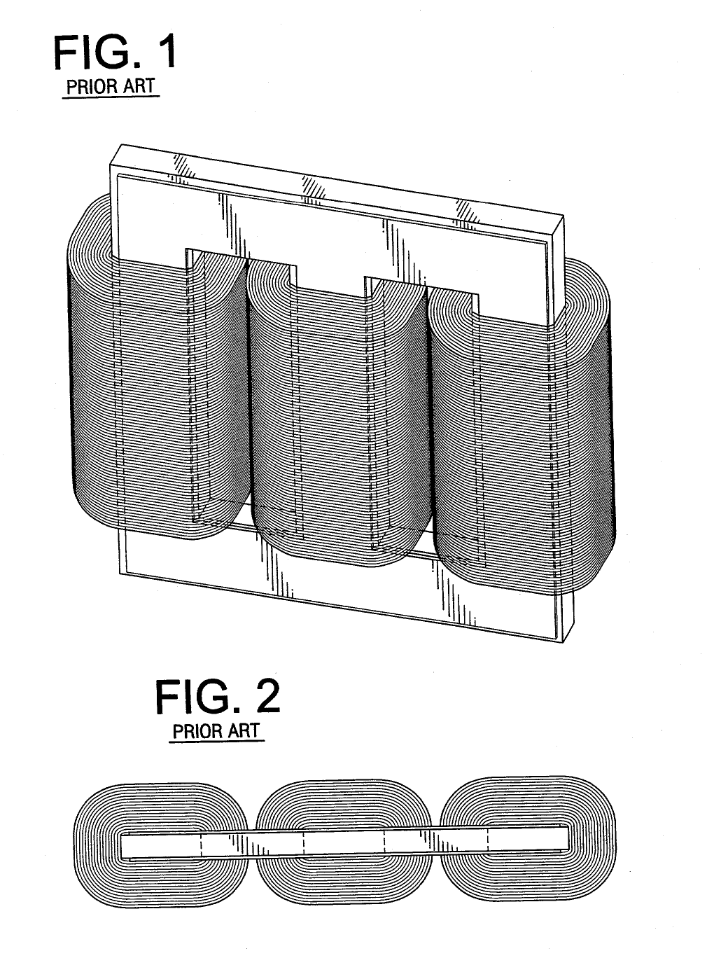

The core leg sections of each embodiment provide a low reluctance path to magnetically link the coils of the transformer. Because of three-dimensional symmetry, there is no increased path length for the left and right phases as there is for the prior art planar core shown in FIGS. 1 and 2. The symmetrical core construction of the present invention requires between 5-12% less steel material than the planar core construction shown in FIGS. 1 and 2, depending on coil size and insulation clearances. Less steel material results in lower transformer losses. Additionally, the three-dimensionally symmetrical magnetic system of the present invention takes up less space than the planar magnetic system.

While the specific embodiments have been illustrated and described, numerous modifications may come to mind without significantly departing from the spirit of the invention, and the scope of protection is only limited by the scope of the accompanying Claims.

What is claimed is:

1. A core for a three-phase transformer, the core comprising a flux collector disposed on a central axis and three core leg sections peripherally arranged about and connected to the flux collector in an angularly spaced relationship, the three core leg sections each adapted to support a transformer coil, the flux collector providing a low reluctance path to magnetically link the coils of the transformer.

2. The core of claim 1, wherein the flux collector has a generally circular-shaped periphery to which the core leg sections are connected.

3. The core of claim 1, wherein the flux collector has a generally triangular-shaped periphery to which the core leg sections are connected.

4. The core of claim 1, wherein the core leg sections each comprise a cut-C core having a leg member and two yoke members each transversely disposed to the leg member to form a general C-shape.

5. The core of claim 4, wherein the core includes two flux collectors each connected to one of the yoke members of each core leg section.

6. The core of claim 1, wherein the core leg sections are formed from core stock comprising laminated sheets of magnetic material.

7. The core of claim 6, wherein the flux collector has a cylindrical shape formed from core stock comprising laminated sheets of magnetic material.

8. A core for a three-phase transformer, the core comprising a flux collector disposed on a central axis and three core leg sections each comprising a leg member and two yoke members each transversely disposed to the leg member to form a general C-shape, the core leg sections peripherally arranged about the flux collector in an angularly spaced relationship such that at least one of the yoke members of each leg section is connected to the flux connector, the three core leg sections each adapted to support a transformer coil and the flux collector adapted to provide a low reluctance path to magnetically link the coils of the transformer.

9. The core of claim 8, wherein the core includes two flux collectors each connected to one of the yoke members of each core leg section.

10. The core of claim 8, wherein the flux collector has a generally circular-shaped periphery to which at least one of the yoke members of each of the core leg sections are connected.

11. The core of claim 8, wherein the flux collector has a generally triangular-shaped periphery to which at least one of the yoke members of each of the core leg sections are connected.

12. The core of claim 8, wherein the core leg sections and the flux collector are formed from core stock comprising laminated sheets of magnetic material.

13. The core of claim 12, wherein the core leg sections are welded to the flux collector.

14. The core of claim 12, wherein the flux collector is formed as a cylinder wound from at least one thin sheet of magnetic material.

15. A core for a three-phase transformer, the core comprising two centrally-disposed flux collectors and three generally C-shaped core leg sections peripherally arranged about the flux collectors in an angularly spaced relationship and connected thereto, the three core leg sections each adapted to support a transformer coil and the flux collector adapted to provide a low reluctance path to magnetically link the coils of the transformer.

16. The core of claim 15, wherein the flux collectors have a generally circular-shaped periphery to which the core leg sections are connected.

17. The core of claim 15, wherein the flux collectors have a generally triangular-shaped periphery to which the core leg sections are connected.

18. The core of claim 15, wherein the core leg sections are formed from core stock comprising laminated sheets of magnetic material.

19. The core of claim 15, wherein the flux collectors have a cylindrical shape formed from core stock comprising laminated sheets of magnetic material.

20. A core for a three-phase transformer, the core comprising a centrally-disposed flux collector and three generally C-shaped core leg sections peripherally arranged about the flux collector in an angularly spaced relationship and connected thereto, the three core leg sections each adapted to support a transformer coil and the flux collector adapted to provide a low reluctance path to magnetically link the coils of the transformer.

21. The core of claim 20, wherein the flux collector has a generally circular-shaped periphery to which the core leg sections are connected.

22. The core of claim 20, wherein the flux collector has a generally triangular-shaped periphery to which the core leg sections are connected.

23. The core of claim 20, wherein the core leg sections are formed from core stock comprising laminated sheets of magnetic material.

24. The core of claim 20, wherein the flux collector has a cylindrical shape formed from core stock comprising laminated sheets of magnetic material.

25. The core of claim 20, wherein the core leg sections each include two yoke members connected to the flux collector.
